(19) United States
(12) Patent Application Publication
(10) Pub. No.: US 2026/0242257 A1
(43) Pub. Date: Aug. 20, 2026

(54) METHOD FOR DESALINATING LIQUID

(71) Applicant: Ming Chi University of Technology, New Taipei City (TW)

(72) Inventors: Yi-Ting LAI, New Taipei City (TW); Chien-Lin HUANG, Kaohsiung City (TW)

(73) Assignee: Ming Chi University of Technology, New Taipei City (TW)

(21) Appl. No.: 19/236,797

(22) Filed: Jun. 12, 2025

(30) Foreign Application Priority Data
Feb. 19, 2025 (TW) 114106104

(51) Int. Cl. C02F 1/469; C02F 1/46; C02F 1/461; C02F 101/12; C02F 103/08

(52) U.S. Cl. CPC C02F 1/4691; C02F 1/4604; C02F 2001/46133; C02F 2001/46161; C02F 2101/12; C02F 2103/08; C02F 2201/46135; C02F 2209/055

(57) ABSTRACT

A method for desalinating a liquid includes: introducing the liquid containing a salt and water into a capacitive deionization device including an electrode unit, followed by applying a voltage to the capacitive deionization device, so that the salt in the liquid is separated therefrom by the electrode unit, and the liquid is converted into a purified liquid. The electrode unit includes a porous positive electrode and a porous negative electrode. Each of the porous positive electrode and the porous negative electrode has a hydrophilic side and a hydrophobic side. The liquid flows from the hydrophobic side of one of the porous positive electrode and the porous negative electrode toward the hydrophilic side of the one of the porous positive electrode and the porous negative electrode, and flows out from the hydrophobic side of another one of the porous positive electrode and the porous negative electrode.

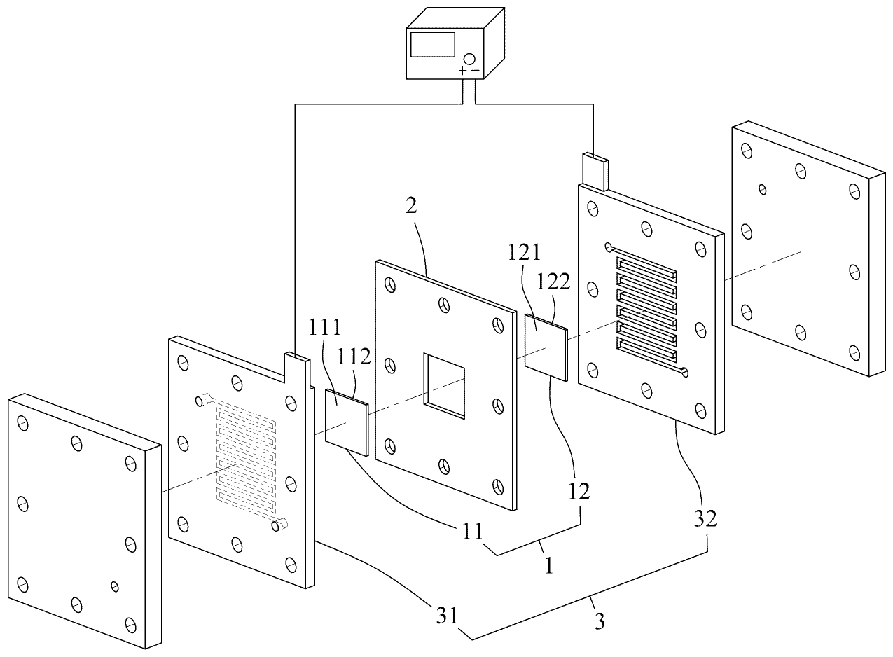

### CROSS-REFERENCE TO RELATED APPLICATION

This application claims priority to Taiwanese Invention Patent Application No. 114106104, filed on Feb. 19, 2025, the entire disclosure of which is incorporated by reference herein.

### FIELD

The disclosure relates to a method for desalinating a liquid.

### BACKGROUND

In recent years, the world has been continuously affected by climate change, and drought disasters occur frequently in various places, resulting in various places taking certain measures, such as supplying water with reduced pressure, limiting water supply, stopping cultivation, suspending business activities, etc., to maintain daily lives. At present, in response to the shortage of water resources, seawater desalination, which has been viewed as a solution that is not affected by the amount of natural rainfall, can provide a stable water supply, and has less adverse impact on the environment. In a conventional seawater desalination method, membrane filtration technique or distillation technique is often adopted. However, such seawater desalination method is not only costly but also energy-consuming. As a result, how to effectively remove a salt (such as sodium chloride) from water is an issue that needs to be solved urgently.

CN 113149143 A discloses a method for synchronously removing salt and organic matters based on hierarchical hydrophobic/hydrophilic electrodes, and the method includes subjecting a system to be treated, which contains oxidants and salt-containing organic wastewater, to a capacitive deionization treatment using a capacitive deionization device, thereby obtaining a purified fresh water. The capacitive deionization device includes a device body, a cathode disposed on the device body, and an anode disposed on the device body and space apart from the cathode. Each of the cathode and the anode may include a hydrophilic porous carbon layer made of hydrophilic porous carbon, and a hydrophobic layer formed on a surface of the hydrophilic porous carbon layer. The hydrophobic layer includes at least one of a hydrophobic conductive polymer layer made of a hydrophobic conductive polymer and a hydrophobically modified metal compound layer.

Although the method disclosed in CN 113149143 A is capable of simultaneously removing the salt from the salt-containing organic wastewater and degrading the organic matters therein, the salt removal rate of the method is still poor.

### SUMMARY

Therefore, an object of the disclosure is to provide a method for desalinating a liquid that can alleviate at least one of the drawbacks of the prior art. The method includes:
introducing the liquid containing a salt and water into a capacitive deionization device including an electrode unit, followed by applying a voltage to the capacitive deionization device, so that the salt in the liquid is separated therefrom by the electrode unit, and the liquid is converted into a purified liquid;
wherein the electrode unit includes a porous positive electrode and a porous negative electrode spaced apart from the porous positive electrode,
wherein each of the porous positive electrode and the porous negative electrode has a hydrophilic side and a hydrophobic side disposed opposite to the hydrophilic side, the hydrophilic side of the porous positive electrode being disposed face to face with the hydrophilic side of the porous negative electrode, and
wherein the liquid flows from the hydrophobic side of one of the porous positive electrode and the porous negative electrode toward the hydrophilic side of the one of the porous positive electrode and the porous negative electrode, and flows out from the hydrophobic side of another one of the porous positive electrode and the porous negative electrode.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The sole FIGURE is a schematic diagram illustrating a capacitive deionization device used in a method for desalinating a liquid according to the present disclosure.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

Referring to the FIGURE, the present disclosure provides a method for desalinating a liquid. The method includes:
introducing the liquid containing a salt and water into a capacitive deionization device including an electrode unit 1, followed by applying a voltage to the capacitive deionization device, so that the salt in the liquid is separated therefrom by the electrode unit 1, and the liquid is converted into a purified liquid.

The method of the present disclosure will be described in detail below.

### [Liquid]

According to the present disclosure, the liquid may be, but is not limited to, seawater, tap water, or wastewater. Examples of the wastewater may include, but are not limited to, domestic wastewater, industrial wastewater, and agricultural wastewater. In certain embodiments, a concentration of the salt in the liquid may range from 60 parts per million (ppm) to 150 ppm. An example of the salt in the liquid may include, but is not limited to, sodium chloride. In an exemplary embodiment, the salt is sodium chloride.

### [Capacitive Deionization Device]

According to the present disclosure, the capacitive deionization device is a flow through-type capacitive deionization device. Referring to the FIGURE, the capacitive deionization device includes the electrode unit 1, a separation unit 2, and a current collecting unit 3.

The electrode unit 1 includes a porous positive electrode 11 and a porous negative electrode 12 spaced apart from the porous positive electrode 11. The porous positive electrode 11 has a hydrophobic side 111 and a hydrophilic side 112 disposed opposite to the hydrophobic side 111. The porous negative electrode 12 has a hydrophilic side 121 and a hydrophobic side 122 disposed opposite to the hydrophilic side 121. The hydrophilic side 112 of the porous positive electrode 11 is disposed face to face with the hydrophilic side 121 of the porous negative electrode 12.

In certain embodiments, a water contact angle of the hydrophilic side 112 of the porous positive electrode 11 may range from 0 degree to 20 degrees. In certain embodiments, the water contact angle of the hydrophilic side 112 of the porous positive electrode 11 may range from 0 degree to 10 degrees. In some embodiments, a water contact angle of the hydrophobic side 111 of the porous positive electrode 11 may range from 130 degrees to 140 degrees.

In certain embodiments, the porous positive electrode 11 may be formed by subjecting a hydrophobic side of a first hydrophobic porous conductor to a modification treatment with a modifier, so that the hydrophobic side of the first hydrophobic porous conductor is converted to the hydrophilic side 112 (i.e., the first hydrophobic porous conductor is converted to the porous positive electrode 11, and the hydrophobic side of the first hydrophobic porous conductor is converted to the hydrophilic side 112 of the porous positive electrode 11). In certain embodiments, the first hydrophobic porous conductor may include a porous conductive member and a hydrophobic material dispersed in the porous conductive member. Examples of the porous conductive member may include, but are not limited to, a porous carbon conductive sheet and a porous conductive polymer membrane. Examples of the porous carbon conductive sheet may include, but are not limited to, a porous carbon felt and a porous activated carbon cloth. An example of the porous conductive polymer membrane may be, but is not limited to, a porous membrane of poly(3,4-ethylenedioxythiophene). In certain embodiments, the hydrophobic material may be selected from the group consisting of a metal oxide, a reduced graphene oxide, a polydimethylsiloxane (PDMS), and combinations thereof. Examples of the metal oxide may include, but are not limited to, zinc oxide, aluminum oxide, and zirconium oxide (ZrO₂). Examples of the modifier may include, but are not limited to, an atmospheric plasma, a chitin, a cellulose, and a pectin.

In certain embodiments, the porous negative electrode 12 may be identical to or different from the porous positive electrode 11.

In certain embodiments, a water contact angle of the hydrophilic side 121 of the porous negative electrode 12 may range from 0 degree to 20 degrees. In certain embodiments, the water contact angle of the hydrophilic side 121 of the porous negative electrode 12 may range from 0 degree to 10 degrees. In some embodiments, a water contact angle of the hydrophobic side 122 of the porous negative electrode 12 may range from 130 degrees to 140 degrees.

In certain embodiments, the porous negative electrode 12 may be formed by subjecting a hydrophobic side of a second hydrophobic porous conductor to a modification treatment with a modifier, so that the hydrophobic side of the second hydrophobic porous conductor is converted to the hydrophilic side 121 (i.e., the second hydrophobic porous conductor is converted to the porous negative electrode 12, and the hydrophobic side of the second hydrophobic porous conductor is converted to the hydrophilic side 121 of the porous negative electrode 12). In certain embodiments, the second hydrophobic porous conductor may include a porous conductive member and a hydrophobic material dispersed in the porous conductive member. Examples of the porous conductive member may include, but are not limited to, a porous carbon conductive sheet and a porous conductive polymer membrane. Examples of the porous carbon conductive sheet may include, but are not limited to, a porous carbon felt and a porous activated carbon cloth. An example of the porous conductive polymer membrane may be, but is not limited to, a porous membrane of poly(3,4-ethylenedioxythiophene). In certain embodiments, the hydrophobic material may be selected from the group consisting of a metal oxide, a reduced graphene oxide, a polydimethylsiloxane (PDMS), and combinations thereof. Examples of the metal oxide may include, but are not limited to, zinc oxide, aluminum oxide, and zirconium oxide (ZrO₂). Examples of the modifier may include, but are not limited to, an atmospheric plasma, a chitin, a cellulose, and a pectin.

According to the present disclosure, the separation unit 2 includes a separator for separating the porous positive electrode 11 from the porous negative electrode 12. That is to say, the separation unit 2 may be disposed between the porous positive electrode 11 and the porous negative electrode 12. The separator may be a conventional separator membrane used in the battery field, such as a cellulose membrane or an ion exchange membrane.

According to the present disclosure, the current collecting unit 3 includes a first current collector 31 located aside of the hydrophobic side 111 of the porous positive electrode 11, and a second current collector 32 located aside of the hydrophobic side 122 of the porous negative electrode 12. The first current collector 31 and the second current collector 32 may be conventional current collectors used in the battery field.

The liquid enters through the first current collector 31, and then contacts the hydrophobic side 111 of the porous positive electrode 11, followed by flowing toward the hydrophilic side 112 of the porous positive electrode 11. Subsequently, the liquid passes through the hydrophilic side 121 of the porous negative electrode 12 and the hydrophobic side 122 of the porous negative electrode 12 in succession, and then flows out from the second current collector 32. It is worth noting that the liquid can enter through the second current collector 32 as well. In other words, the liquid flows from the hydrophobic side 111, 122 of one of the porous positive electrode 11 and the porous negative electrode 12 toward the hydrophilic side 112, 121 of the one of the porous positive electrode 11 and the porous negative electrode 12, and then flows out from the hydrophobic side 122, 111 of another one of the porous positive electrode 11 and the porous negative electrode 12.

In certain embodiments, the voltage may range from 1.4 V to 1.0 V.

By virtue of the positional arrangement of the hydrophobic sides 111, 122 and the hydrophilic sides 112, 121 of the porous positive electrode 11 and the porous negative electrode 12, and under the principle of one-way moisture conduction, flow of the liquid can be effectively guided and controlled in one direction from one of the hydrophobic sides 111, 122 toward a corresponding one of the hydrophilic sides 112, 121. In addition, the liquid can be retained in a space between the hydrophilic sides 112, 121, so as to diffuse therebetween, which allows the salt in the liquid to be effectively absorbed by the electrode unit 1 (i.e., the porous positive electrode 11 and the porous negative electrode 12), so as to separate the salt from the liquid, thereby increasing the desalination rate and improving the purification efficiency in treatment of the liquid. It should be noted that by virtue of the dual wettability characteristic provided by the porous positive electrode 11 and the porous negative electrode 12 of the present disclosure, the liquid can flow from one of the hydrophobic sides 111, 122 to a corresponding one of the hydrophilic sides 112, 121, and then diffuses into the space between the hydrophilic sides 112, 121, thereby greatly improving the desalination rate. Therefore, the purpose of the invention can be achieved.

The disclosure will be further described by way of the following examples. However, it should be understood that the following examples are solely intended for the purpose of illustration and should not be construed as limiting the disclosure in practice.

### EXAMPLES

### Preparation of Porous Positive/Negative Electrode

### Preparative Example (PE)

First, a first mixture, which included 150 mg of graphene oxide (prepared using Hummers' method) and 30 mL of sulfuric acid, was subjected to an oscillation treatment for 30 minutes using an ultrasonic oscillator, so as to uniformly disperse the graphene oxide in the sulfuric acid, thereby obtaining a second mixture. Thereafter, the second mixture was mixed with 60 mg of zinc oxide (prepared using a hydrothermal method) to obtain a third mixture. Subsequently, the third mixture was placed in an electrochemical system, which included a graphite electrode (serving as a counter electrode), a porous carbon felt (serving as a working electrode) (SHANGHAI YONGXIN TOYO TANSO CO., LTD.; Model: SHTS; size: 25 mm in length, 25 mm in width, and 2 mm in thickness; water contact angle: 120 degrees) and a silver chloride electrode (serving as a reference electrode), followed by subjecting the third mixture to a first cyclic voltammetry scan, where 200 scan cycles were performed with each scan cycle being conducted from a starting potential of 1 V to an end potential of −0.1 V and then back to the starting potential (i.e., 1 V), at a scan rate of 0.05 V/s, so that the zinc oxide and the graphene oxide were attached to an interior and a surface of the porous carbon felt. Next, the third mixture was subjected to a second cyclic voltammetry scan, where 10 scan cycles were performed with each scan cycle being conducted from a starting potential of 0 V to an end potential of −1.6 V and then back to the starting potential (i.e., 0 V), at a scan rate of 0.05 V/s, so that the graphene oxide attached to the interior and the surface of the porous carbon felt was reduced to form reduced graphene oxide, thus making the surface of the porous carbon felt hydrophobic, thereby allowing the porous carbon felt to be converted into a hydrophobic porous carbon felt (serving as a hydrophobic porous conductor) having two oppositely arranged hydrophobic sides. In other words, the hydrophobic porous carbon felt included the porous carbon felt, the zinc oxide, and the reduced graphene oxide. Additionally, a water contact angle of each of the hydrophobic sides of the hydrophobic porous carbon felt was 135 degrees.

Next, the hydrophobic porous carbon felt was placed in a plasma treatment equipment (YOU-SHANG TECHNICAL CORP.) with an environment containing an argon gas having a flow rate of 5 slm and a helium gas having a flow rate of 5 sccm, and then one of the hydrophobic sides of the hydrophobic porous carbon felt was subjected to two rounds of surface treatments using an atmospheric plasma under a voltage of 8000 V, so as to convert the one of the hydrophobic sides into a hydrophilic side, thereby obtaining a treated carbon felt (serving as a porous positive electrode 11 or a porous negative electrode 12). In addition, a water contact angle of the hydrophilic side (converted from the one of the hydrophobic sides) of the treated carbon felt was 0 degree.

### Comparative Preparative Example 1 (CPE1)

A porous carbon felt (SHANGHAI YONGXIN TOYO TANSO CO., LTD.; Model: SHTS; size: 25 mm in length, 25 mm in width, and 2 mm in thicknesses) was provided. The porous carbon felt had two oppositely arranged hydrophobic sides, each of which had a water contact angle of 120 degrees.

### Method for Desalinating a Liquid

### Example 1 (E1)

First, 150 L of a liquid containing sodium chloride and water was continuously introduced into a flow through-type capacitive deionization device (see the FIGURE) at a flow rate of 4 mL/min, where a concentration of the sodium chloride in the liquid was 60 parts per million (ppm). The flow-through type capacitive deionization device included an electrode unit 1 including two of the treated carbon felts that were obtained in PE and spaced apart from each other (serving as a porous positive electrode 11 and a porous negative electrode 12, respectively; size of each: 25 mm in length, 25 mm in width, and 2 mm in thickness), and a separator (i.e., a silicone pad) (serving as a separation unit 2) (MISUMI; Model: GELS3-100; size: 100 mm in length, 100 mm in width, and 3 mm in thickness) that had an opening and that was disposed between the two of the treated carbon felts. The hydrophilic sides of the two of the treated carbon felts were disposed face to face with each other.

The liquid entered through the hydrophobic side of one of the two of the treated carbon felts, then diffused and flowed toward the hydrophilic side thereof, and a voltage of 1.2 V was simultaneously applied to the flow through-type capacitive deionization device. After that, the liquid continued flowing, and then flowed out from the hydrophobic side of the other one of the two of the treated carbon felts, so that the sodium chloride in the liquid was absorbed by the two of the treated carbon felts, and hence separated from the liquid, and the liquid was converted into a purified liquid.

### Examples 2 and 3 (E2 and E3)

The procedures for desalinating the liquid of each of E2 and E3 were generally similar to those of E1, except that the concentration of sodium chloride in the liquid was varied as shown in the Table below. A purified liquid of each of E2 and E3 was thus obtained.

### Comparative Example 1 (CE1)

The procedures for desalinating the liquid of CE1 were generally similar to those of E1, except that the two of the treated carbon felts used in E1 were replaced with two of the porous carbon felts of CPE1 (serving as a porous positive electrode and a porous negative electrode, respectively). A purified liquid of CE1 was thus obtained.

### Comparative Example 2 (CE2)

The procedures for desalinating the liquid of CE2 were generally similar to those of E1, except that the hydrophilic side of one of the two of the treated carbon felts (serving as a porous positive electrode and a porous negative electrode, respectively) was disposed face to face with the hydrophobic side of the other one of the two of the treated carbon felts. A purified liquid of CE2 was thus obtained.

### Comparative Example 3 (CE3)

The procedures for desalinating the liquid of CE3 were generally similar to those of E1, except that the hydrophobic sides of the two of the treated carbon felts (serving as a porous positive electrode and a porous negative electrode, respectively) were disposed face to face with each other. A purified liquid of CE3 was thus obtained.

### Comparative Example 4 (CE4)

The procedures for desalinating the liquid of CE4 were generally similar to those of E1, except that the hydrophilic side of one of the two of the treated carbon felts (serving as a porous positive electrode and a porous negative electrode, respectively) was disposed face to face with the hydrophobic side of the other one of the two of the treated carbon felts (the positions of the hydrophilic side and the hydrophobic side are just opposite to those in CE2). A purified liquid of CE4 was thus obtained.

### Property Evaluation

### Determination of Sodium Chloride Absorption Capacity and Sodium Chloride Absorption Rate:

First, a number of standard products with predetermined sodium chloride concentrations were prepared, and then subjected to measurement of electric conductivity using a desktop water quality analyzer (Yellow Springs Instruments; Model: Multilab IDS 4010-3w), so as to plot a relationship between the concentration of sodium chloride and the electric conductivity, thereby obtaining a standard curve formula. After that, the purified liquid of each of E1 to E3 and CE1 to CE3 was subjected to measurement of electric conductivity using the desktop water quality analyzer, so as to obtain an electric conductivity thereof. Next, the value of the electric conductivity thus obtained was substituted into the standard curve formula, so as to determine the concentration of the sodium chloride in the purified liquid.

The sodium chloride absorption capacity I of each example was calculated using the following Equation (I):

$$A 1 = [ ( a \times b ) - ( c \times d ) ] / ( e + f ) \qquad ( I )$$

in which
A1=sodium chloride absorption capacity I of each example (mg/g)
a=concentration of sodium chloride in the liquid (ppm)
b=volume of the liquid (L)
c=concentration of sodium chloride in the purified liquid (ppm)
d=volume of the purified liquid (L)
e=weight of porous positive electrode (g)
f=weight of porous negative electrode (g)

The results are shown in the Table below.

The sodium chloride absorption capacity II of each example was calculated using the following Equation (II):

$$A 2 = [ ( a \times b ) - ( c \times d ) ] / g \qquad ( II )$$

in which
A2=sodium chloride absorption capacity II of each example (mg/cm²)
a=concentration of sodium chloride in the liquid (ppm)
b=volume of the liquid (L)
c=concentration of sodium chloride in the purified liquid (ppm)
d=volume of the purified liquid (L)
g=area of the opening of the separator (cm²)

The results are shown in the Table below.

The sodium chloride absorption rate of each example was calculated using the following Equation (III):

$$R = \{ [ ( a \times b ) - ( c \times d ) ] / ( a \times b ) \} \times 100 \% \qquad ( III )$$

in which
R=sodium chloride absorption rate of each example (%)
a=concentration of sodium chloride in the liquid (ppm)
b=volume of the liquid (L)
c=concentration of sodium chloride in the purified liquid (ppm)
d=volume of the purified liquid (L)

The results are shown in the Table below.

TABLE

| | | | Concentration | Sodium | Sodium | |
|---|---|---|---|---|---|---|
| | | | of sodium | chloride | chloride | Sodium |
| | Porous | Porous | chloride in | absorption | absorption | chloride |
| | positive | negative | the liquid | capacity I | capacity II | absorption |
| | electrode | electrode | (ppm) | (mg/g) | (mg/cm²) | rate (%) |
| E1 | Treated carbon felts | | 60 | 34.380 | 0.75 | 33.5 |
| E2 | of PE | | 100 | 79.320 | 1.73 | 46.2 |
| E3 | | | 150 | 133.740 | 2.92 | 51.1 |
| CE1 | Porous carbon felts | | 60 | 6.210 | 0.12 | 0.5 |
| | of CPE1 | | | | | |
| CE2 | Treated carbon felts | | 60 | 28.020 | 0.57 | 25 |
| CE3 | of PE | | 60 | 31.315 | 0.68 | 30 |
| CE4 | | | 60 | 32.350 | 0.70 | 31 |

It can be seen from the Table that either one of the sodium chloride absorption capacity I and the sodium chloride absorption capacity II of E1 (in which desalination of the liquid was conducted by the method according to the present disclosure) was higher than that of each of CE1 to CE3 (in which desalination of the liquid was not conducted by the method according to the present disclosure), and the sodium chloride absorption rate of E1 was also higher than that of each CE1 to CE3. In addition, either one of the sodium chloride absorption capacity I and the sodium chloride absorption capacity II of each of E2 and E3 (in which desalination of the liquid was conducted by the method according to the present disclosure) was higher than that of E1, and the sodium chloride absorption rate of each of E2 and E3 was also higher than that of E1, indicating that in a situation where the concentration of sodium chloride in a liquid becomes higher, the performance of desalination using the method according to the present disclosure may be improved. These results show that by virtue of the method for desalinating a liquid according to the present disclosure, the capability of removing a salt (e.g., the sodium chloride) in the liquid can indeed be enhanced, either with respect to absorption capacity of the salt or absorption rate thereof.

Summarizing the above test results, it is clear that by virtue of the positional arrangement of the hydrophobic sides 111, 122 and the hydrophilic sides 112, 121 of the porous positive electrode 11 and the porous negative electrode 12 (i.e., allowing hydrophilic sides 112, 121 thereof to be disposed face to face with each other), and under the principle of one-way moisture conduction, flow of the liquid can be effectively guided and controlled in one direction from one of the hydrophobic sides 111, 122 toward a corresponding one of the hydrophilic sides 112, 121. In addition, the liquid retained in a space between the hydrophilic sides 112, 121 can diffuse therebetween, which allows the salt, e.g., the sodium chloride, in the liquid to be effectively absorbed by the electrode unit 1 (i.e., the porous positive electrode 11 and the porous negative electrode 12), so as to separate the salt from the liquid, thereby increasing the desalination rate and improving the purification efficiency in treatment of the liquid. It is worth noting that by virtue of the dual wettability characteristic provided by the porous positive electrode 11 and the porous negative electrode 12 of the present disclosure, the liquid can flow from one of the hydrophobic sides 111, 122 to a corresponding one of the hydrophilic sides 112, 121, and then diffuse into the space between the hydrophilic sides 112, 121, thereby greatly improving the desalination rate. Therefore, the purpose of the invention can be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for desalinating a liquid, comprising:
introducing the liquid containing a salt and water into a capacitive deionization device including an electrode unit, followed by applying a voltage to the capacitive deionization device, so that the salt in the liquid is separated therefrom by the electrode unit, and the liquid is converted into a purified liquid;
wherein the electrode unit includes a porous positive electrode and a porous negative electrode spaced apart from the porous positive electrode,
wherein each of the porous positive electrode and the porous negative electrode has a hydrophilic side and a hydrophobic side disposed opposite to the hydrophilic side, the hydrophilic side of the porous positive electrode being disposed face to face with the hydrophilic side of the porous negative electrode, and
wherein the liquid flows from the hydrophobic side of one of the porous positive electrode and the porous negative electrode toward the hydrophilic side of the one of the porous positive electrode and the porous negative electrode, and flows out from the hydrophobic side of another one of the porous positive electrode and the porous negative electrode.

2. The method as claimed in claim 1, wherein a water contact angle of the hydrophilic side of the porous positive electrode ranges from 0 degree to 20 degrees.

3. The method as claimed in claim 2, wherein the water contact angle of the hydrophilic side of the porous positive electrode ranges from 0 degree to 10 degrees.

4. The method as claimed in claim 3, wherein a water contact angle of the hydrophobic side of the porous positive electrode ranges from 130 degrees to 140 degrees.

5. The method as claimed in claim 1, wherein a water contact angle of the hydrophilic side of the porous negative electrode ranges from 0 degree to 20 degrees.

6. The method as claimed in claim 5, wherein the water contact angle of the hydrophilic side of the porous negative electrode ranges from 0 degree to 10 degrees.

7. The method as claimed in claim 6, wherein a water contact angle of the hydrophobic side of the porous negative electrode ranges from 130 degrees to 140 degrees.

8. The method as claimed in claim 1, wherein the voltage ranges from 1.4 V to 1 V.

9. The method as claimed in claim 1, wherein the salt is sodium chloride.

10. The method as claimed in claim 1, wherein a concentration of the salt in the liquid ranges from 60 parts per million (ppm) to 150 ppm.

11. The method as claimed in claim 1, wherein the porous positive electrode is identical to or different from the porous negative electrode.

12. The method as claimed in claim 11, wherein each of the porous positive electrode and the porous negative electrode is formed by subjecting a hydrophobic side of a hydrophobic porous conductor to a modification treatment with a modifier, so that the hydrophobic side of the hydrophobic porous conductor is converted to the hydrophilic side.

13. The method as claimed in claim 12, wherein the hydrophobic porous conductor includes a porous conductive member and a hydrophobic material dispersed in the porous conductive member.

14. The method as claimed in claim 13, wherein the hydrophobic material is selected from the group consisting of a metal oxide, a reduced graphene oxide, a polydimethylsiloxane, and combinations thereof.

15. The method as claimed in claim 1, wherein the capacitive deionization device further includes a separation unit disposed between the porous positive electrode and the porous negative electrode.
